(19) United States
(12) Patent Application Publication
(10) Pub. No.: US 2012/0096323 A1
(43) Pub. Date: Apr. 19, 2012

(54) DIAGNOSTIC CIRCUIT AND SEMICONDUCTOR INTEGRATED CIRCUIT

(75) Inventor: Fumihiko TACHIBANA, Koganei-shi (JP)

(73) Assignee: KABUSHIKI KAISHA TOSHIBA, Tokyo (JP)

(21) Appl. No.: 13/069,298

(22) Filed: Mar. 22, 2011

(30) Foreign Application Priority Data
Oct. 14, 2010 (JP) 2010-231088

(51) Int. Cl. G06F 11/00

(52) U.S. Cl. 714/719; 714/E11.02

(57) ABSTRACT

According to one embodiment, a certain amount of data is held in the memory cells, and after a state of the data held in the memory cell is transferred into an indefinite state, data autonomously held in the memory cell is read, and a change of the threshold voltage of transistors is diagnosed on the basis of the distribution of the data autonomously held in the memory cell.

### CROSS-REFERENCE TO RELATED APPLICATIONS

This application is based upon and claims the benefit of priority from the prior Japanese Patent Application No. 2010-231088, filed on Oct. 14, 2010; the entire contents of which are incorporated herein by reference.

### FIELD

Embodiments described herein relate generally to a diagnostic circuit and a semiconductor integrated circuit.

### BACKGROUND

It is known that a PMOS transistor degrades over time due to NBTI. The degradation over time due to NBTI is a phenomenon in which, when an ON state of the PMOS transistor continues for a long time under a high-temperature condition, a threshold voltage of the PMOS transistor rises and a current driving ability falls.

Although it is known that an NMOS transistor degrades over time due to PBTI, the degree of the degradation due to PBTI is incomparably smaller than the degree of the degradation due to NBTI.

When the threshold voltage changes due to PBTI or NBTI, characteristics of a semiconductor integrated circuit degrade. Therefore, it is important to diagnose how much the threshold voltage has changed due to PBTI or NBTI when a semiconductor integrated circuit is used.

### BRIEF DESCRIPTION OF THE DRAWINGS

FIG. 1 is a block diagram illustrating a schematic configuration of a diagnostic circuit according to a first embodiment;

FIG. 2 is a diagram illustrating a circuit configuration of a memory cell of the diagnostic circuit in FIG. 1;

FIG. 3 is a timing chart illustrating voltage waveforms of each portion of the memory cell in FIG. 2;

FIG. 4 is a diagram illustrating distributions of read data, which is read from the memory cells of the diagnostic circuit according to the first embodiment, in an initial state and a state after stress is applied;

FIG. 5 is a timing chart illustrating voltage waveforms of each portion of a memory cell of a diagnostic circuit according to a second embodiment;

FIG. 6 is a diagram illustrating distributions of read data, which is read from the memory cells of the diagnostic circuit according to the second embodiment, in an initial state and a state after stress is applied;

FIG. 7 is a block diagram illustrating a schematic configuration of a diagnostic circuit according to a third embodiment;

FIG. 8 is a diagram illustrating a circuit configuration of a memory cell of the diagnostic circuit in FIG. 7;

FIG. 9 is a timing chart illustrating voltage waveforms of each portion of the memory cell in FIG. 8;

FIG. 10 is a block diagram illustrating a schematic configuration of a semiconductor integrated circuit to which a diagnostic circuit according to a fourth embodiment is applied;

FIG. 11 is a block diagram illustrating a schematic configuration of a semiconductor integrated circuit to which a diagnostic circuit according to a fifth embodiment is applied;

FIG. 12 illustrates an example of a method of a job assignment of the semiconductor integrated circuit illustrated in FIG. 11; and

FIG. 13 illustrates another example of a method of a job assignment of the semiconductor integrated circuit illustrated in FIG. 11.

### DETAILED DESCRIPTION

In general, according to one embodiment, a diagnostic circuit comprises a memory cell array in which memory cells that complementarily store data in a pair of storage nodes are arranged; an input/output circuit configured to make the memory cells hold a certain amount of data, and read data autonomously held in the memory cells after a state of the data held in the memory cells is transferred into an indefinite state; and a diagnostic unit configured to diagnose a change of a threshold voltage of transistors on the basis of distribution of the data autonomously held in the memory cells.

Exemplary embodiments of a diagnostic circuit will be explained below in detail with reference to the accompanying drawings. The present invention is not limited to the following embodiments. cl First Embodiment

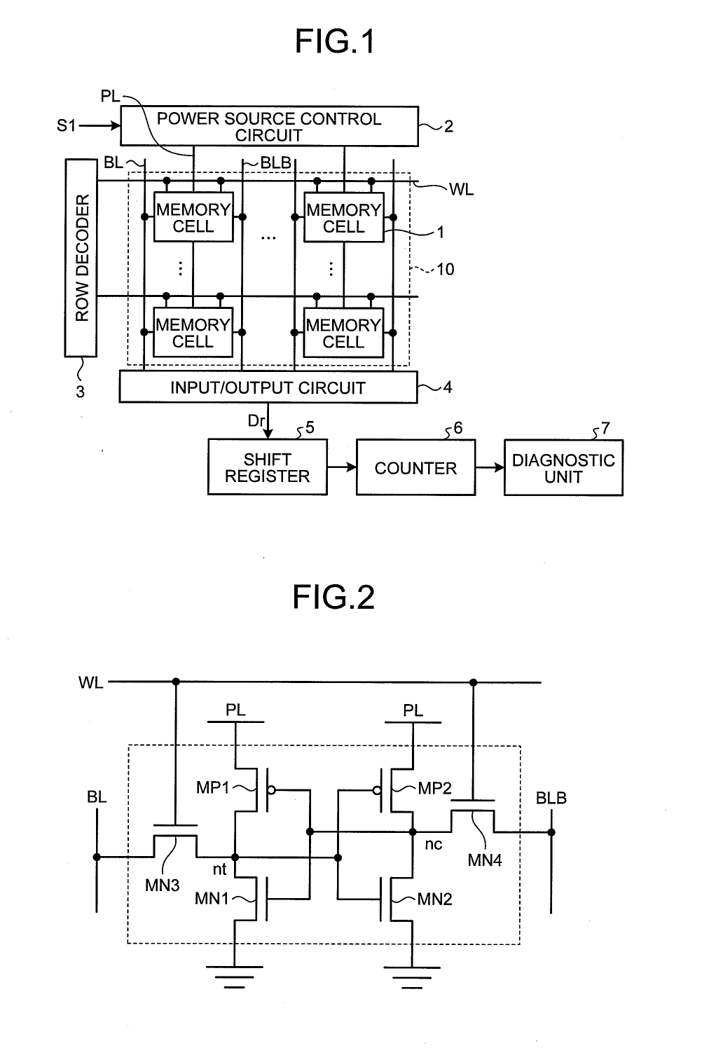

FIG. 1 is a block diagram illustrating a schematic configuration of a diagnostic circuit according to a first embodiment.

In FIG. 1, the diagnostic circuit includes a memory cell array 10, a power source control circuit 2, a row decoder 3, an input/output circuit 4, a shift register 5, a counter 6, and a diagnostic unit 7.

In the memory cell array 10, memory cells 1 are arranged in a row direction and a column direction in a matrix form. The memory cell 1 can complementarily store data in a pair of storage nodes. For example, an SRAM cell can be used as the memory cell 1.

The power source control circuit 2 can fix the data held in the memory cell 1 by supplying power to the memory cell 1, and make the state of the data held in the memory cell 1 move into an indefinite state by dropping the potential of the power supplied to the memory cell 1 to the ground potential. The row decoder 3 can select the memory cells 1 in the row direction.

The input/output circuit 4 can write data to the memory cell 1 and read data from the memory cell 1. In the input/output circuit 4, a column decoder for selecting the memory cells 1 in the column direction and a sense amplifier for detecting whether the data read from the memory cell 1 is “0” or “1” can be provided.

The shift register 5 can store data read from the memory cell 1. The counter 6 can count the number of data read from the memory cell 1 whose value is “0” or the number of data read from the memory cell 1 whose value is “1”. The diagnostic unit 7 can diagnose a change of a threshold voltage of transistors on the basis of the result of the count performed by the counter 6.

FIG. 2 is a diagram illustrating a circuit configuration of a memory cell of the diagnostic circuit in FIG. 1. The memory cell is assumed to be an SRAM including 6 transistors as an example.

In FIG. 2, in the memory cell 1, a P-channel field-effect transistors MP1 and MP2 and N-channel field-effect transistors MN1 to MN4.

The P-channel field-effect transistor MP1 and the N-channel field-effect transistor MN1 are connected to each other in series to form a CMOS inverter, and the P-channel field-effect transistor MP2 and the N-channel field-effect transistor MN2 are connected to each other in series to form a CMOS inverter. The outputs and inputs of the pair of the CMOS inverters are cross-coupled with each other to form a flip-flop. The sources of the P-channel field-effect transistors MP1 and MP2 are connected to a power source line PL, and the sources of the N-channel field-effect transistors MN1 and MN2 are grounded.

A word line WL is connected to the gates of the N-channel field-effect transistors MN3 and MN4. A bit line BL is connected to the gate of the P-channel field-effect transistor MP2, the gate of the N-channel field-effect transistor MN2, the drain of the P-channel field-effect transistor MP1, and the drain of the N-channel field-effect transistor MN1 through the N-channel field-effect transistor MN3. A bit line BLB is connected to the drain of the P-channel field-effect transistor MP2, the drain of the N-channel field-effect transistor MN2, the gate of the P-channel field-effect transistor MP1, and the gate of the N-channel field-effect transistor MN1 through the N-channel field-effect transistor MN4.

Here, a connection point between the drain of the P-channel field-effect transistor MP1 and the drain of the N-channel field-effect transistor MN1 can form a storage node nt, and the drain of the P-channel field-effect transistor MP2 and the drain of the N-channel field-effect transistor MN2 can form a storage node nc.

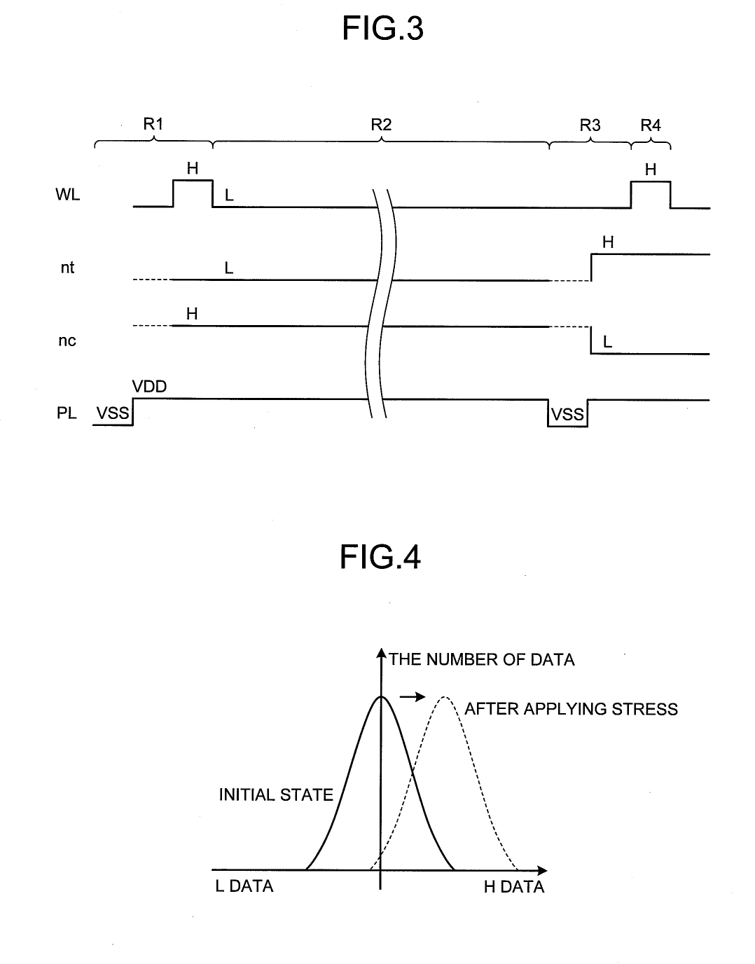

FIG. 3 is a timing chart illustrating voltage waveforms of each portion of the memory cell in FIG. 2.

In FIG. 3, in a writing period R1, the power source line PL is set from a ground potential VSS to a power source potential VDD. Then in a state in which the bit line BL is set to low level and the bit line BLB is set to high level, if the word line WL is set to high level, the storage node nt is transferred to low level and the storage node nc is transferred to high level.

Next, in a stress application period R2, while the power source line PL is still set to the power source potential VDD, the word line WL is transferred to low level, and the storage node nt is held at low level and the storage node nc is held at high level.

Therefore, the gate potential of the P-channel field-effect transistor MP2 becomes low level, and the threshold voltage of the P-channel field-effect transistor MP2 increases due to NBTI. The gate potential of the N-channel field-effect transistor MN1 becomes high level, and the threshold voltage of the N-channel field-effect transistor MN1 increases due to PBTI.

On the other hand, the gate potential of the P-channel field-effect transistor MP1 becomes high level, and an increase of the threshold voltage of the P-channel field-effect transistor MP1 due to NBTI does not occur. The gate potential of the N-channel field-effect transistor MN2 becomes low level, and an increase of the threshold voltage of the N-channel field-effect transistor MN2 due to PBTI does not occur.

Next, in a rewriting period R3, an equalize signal S1 is inputted into the power source control circuit 2 and the potential of the power supplied to the memory cell 1 is dropped to the ground potential VSS, and thereby the state of the data held in the memory cell 1 is transferred into an indefinite state. Thereafter, the potential of the power supplied to the memory cell 1 is raised from the ground potential VSS to the power source potential VDD. At this time, even if write data is not provided via the bit lines BL and BLB, data is autonomously held in the memory cell 1. Here, since the threshold voltages of the P-channel field-effect transistor MP2 and the N-channel field-effect transistor MN1 have increased, the storage node nt tends to move to high level and the storage node nc tends to move to low level. Therefore, when data is autonomously held in the memory cell 1, the probability that the storage node nt is held at high level and the storage node nc is held at low level increases.

Next, in a reading period R4, the word line WL is set to high level, and thereby the data stored in the memory cell 1 is transmitted to the input/output circuit 4 via the bit lines BL and BLB. Then, in the input/output circuit 4, whether the data stored in the memory cell 1 is “0” or “1” is detected, and the detection result is once stored in the shift register 5 as read data Dr. Then, in the counter 6, the number of the read data Dr whose value is “0” and the number of the read data Dr whose value is “1” are counted, and the count results are sent to the diagnostic unit 7.

The operations in the writing period R1 and the stress application period R2 can be performed when a circuit block diagnosed by the diagnostic circuit operates.

In the diagnostic unit 7, an increase amount of the threshold voltage of the transistors is determined on the basis of a ratio of the number of the read data Dr whose value is “1” to the number of the read data Dr whose value is “0”. Here, there is a correlation between the ratio of the number of the read data Dr whose value is “1” to the number of the read data Dr whose value is “0” and the increase amount of the threshold voltage of the transistors. The larger the number of the read data Dr whose value is “1” is than the number of the read data Dr whose value is “0”, the larger the increase amount of the threshold voltage of the transistors is.

A quantitative relationship between the ratio of the number of the read data Dr whose value is “1” to the number of the read data Dr whose value is “0” and the increase amount of the threshold voltage of the transistors can be obtained in advance by simulation or actual measurement.

In this way, it is possible to diagnose how much the threshold voltage of the transistors has changed due to PBTI or NBTI, so that it is possible to estimate how much the characteristics of the semiconductor circuit have degraded when the semiconductor circuit is used.

FIG. 4 is a diagram illustrating distributions of the read data, which is read from the memory cells of the diagnostic circuit according to the first embodiment, in an initial state and a state after stress is applied.

In FIG. 4, in the initial state, degradation of the P-channel field-effect transistor MP2 due to NBTI does not occur. Therefore, the threshold voltages of the P-channel field-effect transistors MP1 and MP2 are equal to each other. Similarly, in the initial state, degradation of the N-channel field-effect transistor MN1 due to PBTI does not occur. Therefore, the threshold voltages of the N-channel field-effect transistors MN1 and MN2 are equal to each other. Therefore, the number of the read data Dr whose value is “0” and the number of the read data Dr whose value is “1” are equal to each other, so that the distribution of the read data is symmetric between L data and H data.

After applying stress during the stress application period R2, degradation of the P-channel field-effect transistor MP2 occurs due to NBTI. Therefore, the threshold voltage of the P-channel field-effect transistor MP2 becomes larger than the threshold voltage of the P-channel field-effect transistor MP1. Similarly, after applying stress, degradation of the N-channel field-effect transistor MN1 due to PBTI occurs. Therefore, the threshold voltage of the N-channel field-effect transistor MP1 becomes larger than the threshold voltage of the N-channel field-effect transistor MP2. Therefore, the number of the read data Dr whose value is “1” becomes larger than the number of the read data Dr whose value is “0”, and the distribution of the read data shifts to H data.

By measuring how much the distribution of the read data shifts to H data, it is possible to estimate the increase amount of the threshold voltage of the transistors due to NBTI and PBTI.

To shorten the time for diagnosing the change of the threshold voltage, data may be collectively read from the memory cells 1 in the row direction.

When turning off or on the power of the memory cells 1, it is possible to collectively turn on or off the memory cells 1′ in the row direction, collectively turn on or off the memory cells 1 in the column direction, or collectively turn on or off all the memory cells 1.

### Second Embodiment

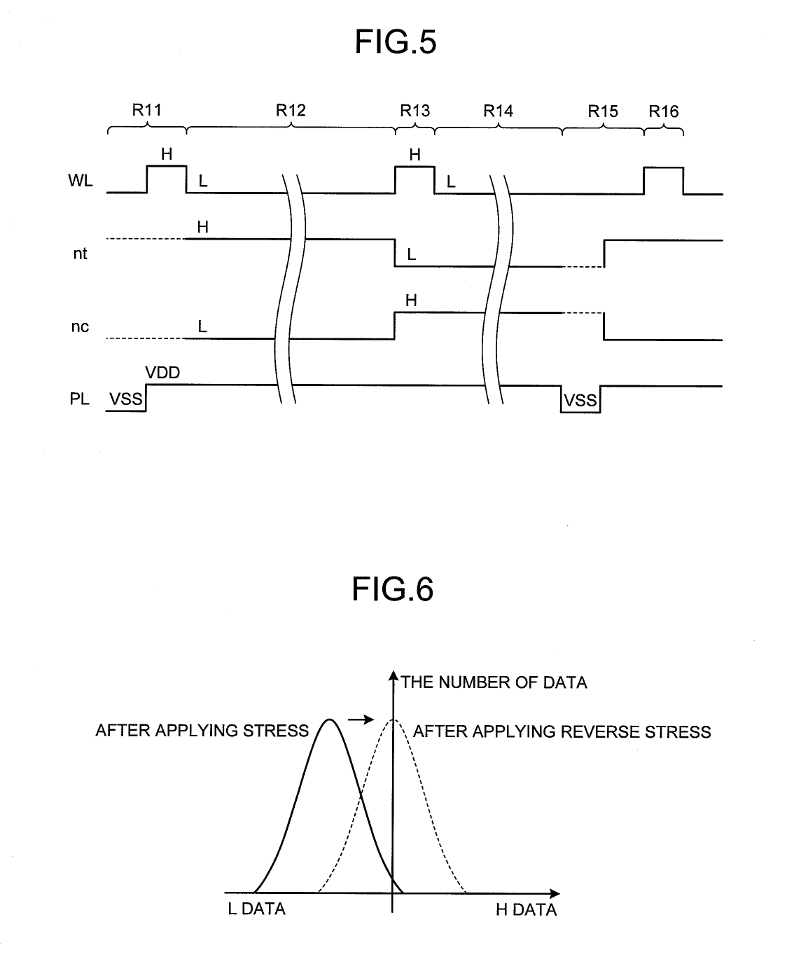

FIG. 5 is a timing chart illustrating voltage waveforms of each portion of a memory cell of a diagnostic circuit according to a second embodiment.

In FIG. 5, in a writing period R11, the power source line PL is set from the ground potential VSS to the power source potential VDD. Then in a state in which the bit line BL is set to high level and the bit line BLB is set to low level, if the word line WL is set to high level, the storage node nt is transferred to high level and the storage node nc is transferred to low level.

Next, in a stress application period R12, while the power source line PL is still set to the power source potential VDD, the word line WL is transferred to low level, and the storage node nt is held at high level and the storage node nc is held at low level.

Therefore, the gate potential of the P-channel field-effect transistor MP1 becomes low level, and the threshold voltage of the P-channel field-effect transistor MP1 increases due to NBTI. The gate potential of the N-channel field-effect transistor MN2 becomes high level, and the threshold voltage of the N-channel field-effect transistor MN2 increases due to PBTI.

In the stress application period R12, it is preferable to apply stress to be able to determine that the useful life has ended when the number of data “1” and the number of data “0” stored in the memory cells 1 are the same.

Next, in a writing period R13, in a state in which the bit line BL is set to low level and the bit line BLB is set to high level, if the word line WL is set to high level, the storage node nt is transferred to low level and the storage node nc is transferred to high level.

Next, in a reverse stress application period R14, while the power source line PL is still set to the power source potential VDD, the word line WL is transferred to low level, and the storage node nt is held at low level and the storage node nc is held at high level.

Therefore, the gate potential of the P-channel field-effect transistor MP2 becomes low level, and the threshold voltage of the P-channel field-effect transistor MP2 increases due to NBTI. The gate potential of the N-channel field-effect transistor MN1 becomes high level, and the threshold voltage of the N-channel field-effect transistor MN1 increases due to PBTI.

Next, in a rewriting period R15, the potential of the power supplied to the memory cell 1 is dropped to the ground potential VSS, and thereby the state of the data held in the memory cell 1 is transferred into an indefinite state. Thereafter, the potential of the power supplied to the memory cell 1 is raised from the ground potential VSS to the power source potential VDD. Here, the threshold voltages of the P-channel field-effect transistors MP1 and MP2 and the N-channel field-effect transistors MN1 and MN2 are all increased. Therefore, when data is autonomously held in the memory cell 1, the probability that the storage node nt is held at high level and the probability that the storage node nt is held at low level are nearly the same.

Next, in a reading period R16, the word line WL is set to high level, and thereby the data stored in the memory cell 1 is transmitted to the input/output circuit 4 via the bit lines BL and BLB. Then, in the input/output circuit 4, whether the data stored in the memory cell 1 is “0” or “1” is detected, and the detection result is once stored in the shift register 5 as read data Dr. Then, in the counter 6, the number of the read data Dr whose value is “0” and the number of the read data Dr whose value is “1” are counted, and the count results are sent to the diagnostic unit 7.

The operations in the writing period R11 and the stress application period R12 can be performed in advance when a circuit block diagnosed by the diagnostic circuit does not operate, and a desired stress can be applied before shipping, for example. The operations in the writing period R13 and the reverse stress application period R14 can be performed when the circuit block diagnosed by the diagnostic circuit operates.

In the diagnostic unit 7, it is determined whether or not the number of the read data Dr whose value is “0” and the number of the read data Dr whose value is “1” are the same. If the number of the read data Dr whose value is “0” and the number of the read data Dr whose value is “1” are the same, it is determined that an increase amount of the threshold voltage of the transistors in the stress application period R12 is an increase amount of the threshold voltage of the transistors in the reverse stress application period R14.

In this way, by obtaining the increase amount of the threshold voltage of the transistors in the stress application period R12 in advance, it is possible to diagnose how much the threshold voltage of the transistors has changed due to PBTI or NBTI, so that it is possible to estimate how much the characteristics of the semiconductor circuit have degraded when the semiconductor circuit is used.

FIG. 6 is a diagram illustrating distributions of read data, which is read from the memory cells of the diagnostic circuit according to the second embodiment, in an initial state and a state after stress is applied.

In FIG. 6, after applying stress during the stress application period R12 in FIG. 5, degradation of the P-channel field-effect transistor MP1 occurs due to NBTI. Therefore, the threshold voltage of the P-channel field-effect transistor MP1 becomes larger than the threshold voltage of the P-channel field-effect transistor MP2. Similarly, after applying stress during the stress application period R12, degradation of the N-channel field-effect transistor MN2 due to PBTI occurs. Therefore, the threshold voltage of the N-channel field-effect transistor MN2 becomes larger than the threshold voltage of the N-channel field-effect transistor MN1. Therefore, the number of the read data Dr whose value is “0” becomes larger than the number of the read data Dr whose value is “1”, and the distribution of the read data shifts to L data.

After applying reverse stress during the reverse stress application period R14 in FIG. 5, degradation of the P-channel field-effect transistor MP2 occurs due to NBTI. Therefore, the threshold voltage of the P-channel field-effect transistor MP1 becomes equal to the threshold voltage of the P-channel field-effect transistor MP2. Similarly, after applying reverse stress during the reverse stress application period R14, degradation of the N-channel field-effect transistor MN1 due to PBTI occurs. Therefore, the threshold voltage of the N-channel field-effect transistor MN2 becomes equal to the threshold voltage of the N-channel field-effect transistor MN2. Therefore, the number of the read data Dr whose value is “0” and the number of the read data Dr whose value is “1” are equal to each other, so that the distribution of the read data is symmetric between L data and H data.

By measuring an increase amount of the threshold voltage of the transistors in the stress application period R12 in advance, it is possible to estimate an increase amount of the threshold voltage of the transistors due to NBTI and PBTI after the reverse stress application period R14.

### Third Embodiment

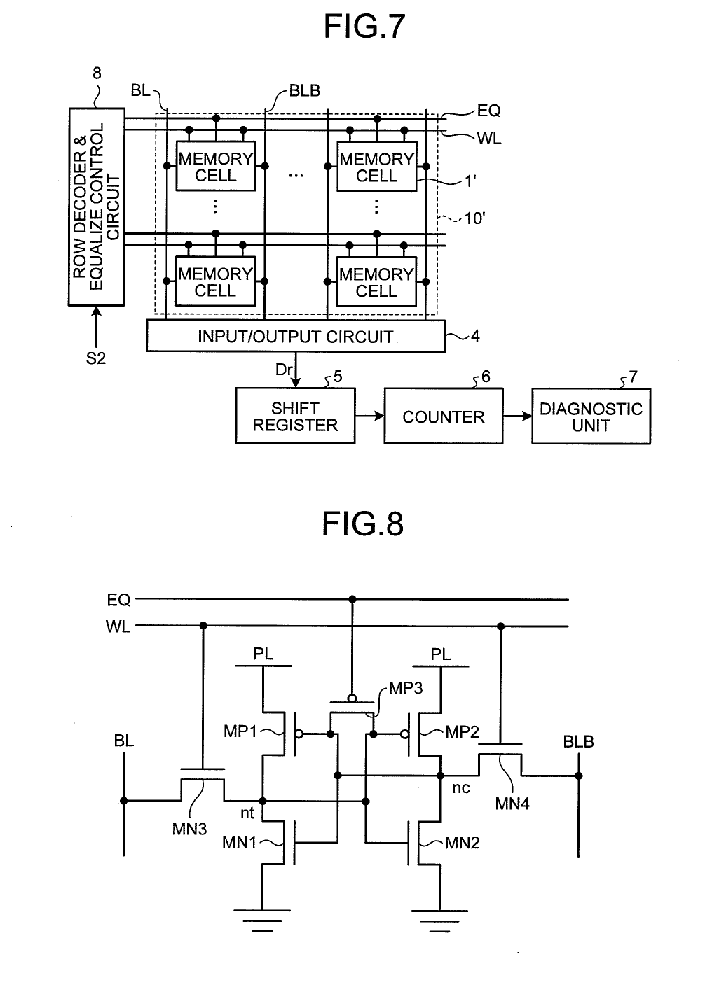

FIG. 7 is a block diagram illustrating a schematic configuration of a diagnostic circuit according to a third embodiment.

In FIG. 7, the diagnostic circuit includes a memory cell array 10′ instead of the memory cell array 10 of the diagnostic circuit in FIG. 1 and a row decoder & equalize control circuit 8 instead of the power source control circuit 2 and the row decoder 3 of the diagnostic circuit in FIG. 1. The memory cell array 10′ includes memory cells 1′ instead of the memory cells 1 in FIG. 1.

FIG. 8 is a diagram illustrating a circuit configuration of a memory cell of the diagnostic circuit in FIG. 7.

In FIG. 8, a P-channel field-effect transistor MP3 is added to the memory cell 1′. The drain of the P-channel field-effect transistor MP3 is connected to the storage node nt and the source of the P-channel field-effect transistor MP3 is connected to the storage node nc. The gate of the P-channel field-effect transistor MP3 is connected to an equalize line EQ.

In FIG. 7, the row decoder & equalize control circuit 8 can transfer a state of data held in the memory cell 1′ into an indefinite state by selecting the memory cell 1′ in the row direction or short-circuiting the storage nodes nt and nc to each other.

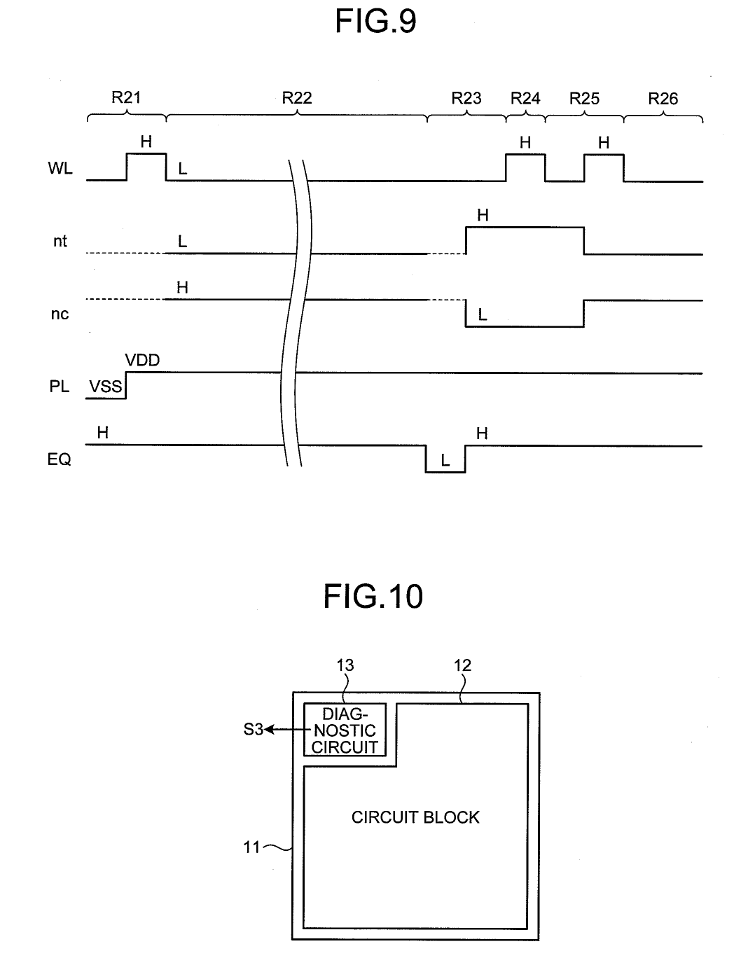

FIG. 9 is a timing chart illustrating voltage waveforms of each portion of the memory cell in FIG. 8.

In FIG. 9, in a writing period R21, the power source line PL is set from the ground potential VSS to the power source potential VDD. The equalize line EQ is held at high level. Then in a state in which the bit line BL is set to low level and the bit line BLB is set to high level, if the word line WL is set to high level, the storage node nt is transferred to low level and the storage node nc is transferred to high level.

Next, in a stress application period R22, while the power source line PL is still set to the power source potential VDD, the word line WL is transferred to low level, and the storage node nt is held at low level and the storage node nc is held at high level.

Therefore, the gate potential of the P-channel field-effect transistor MP2 becomes low level, and the threshold voltage of the P-channel field-effect transistor MP2 increases due to NBTI. The gate potential of the N-channel field-effect transistor MN1 becomes high level, and the threshold voltage of the N-channel field-effect transistor MN1 increases due to PBTI.

Next, in a rewriting period R23, an equalize signal S2 is inputted into the row decoder & equalize control circuit 8, and the equalize line EQ is transferred to low level. Therefore, the P-channel field-effect transistor MP3 is turned on and the storage nodes nt and nc are short-circuited to each other, and thereby the state of the data held in the memory cell 1′ is transferred into an indefinite state. Thereafter, the equalize line EQ is transferred to high level and the P-channel field-effect transistor MP3 is turned off, and thereby the storage nodes nt and nc are disconnected from each other. At this time, even if write data is not provided via the bit lines BL and BLB, data is autonomously held in the memory cell 1′. Here, since the threshold voltages of the P-channel field-effect transistor MP2 and the N-channel field-effect transistor MN1 have increased, the storage node nt tends to move to high level and the storage node nc tends to move to low level. Therefore, when data is autonomously held in the memory cell 1′, the probability that the storage node nt is held at high level and the storage node nc is held at low level increases.

Next, in a reading period R24, the word line WL is set to high level, and thereby the data stored in the memory cell 1′ is transmitted to the input/output circuit 4 via the bit lines BL and BLB. Then, in the input/output circuit 4, whether the data stored in the memory cell 1′ is “0” or “1” is detected, and the detection result is once stored in the shift register 5 as read data Dr. Then, in the counter 6, the number of the read data Dr whose value is “0” and the number of the read data Dr whose value is “1” are counted, and the count results are sent to the diagnostic unit 7. In the diagnostic unit 7, an increase amount of the threshold voltage of the transistors is determined on the basis of a ratio of the number of the read data Dr whose value is “1” to the number of the read data Dr whose value is “0”.

Next, in a re-writing period R25, after the read data Dr is read, the original data is rewritten to the memory cell 1′, and the storage node nt is transferred to low level and the storage node nc is transferred to high level.

In a stress re-application period R26, while the equalize line EQ is still set to high level, the word line WL is transferred to low level, and the storage node nt is held at low level and the storage node nc is held at high level.

The operations in the writing period R21, the stress application period R22, the rewriting period R23, the reading period R24, the re-writing period R25, and the stress re-application period R26 can be performed when a circuit block diagnosed by the diagnostic circuit operates.

In this way, the time taken to autonomously rewrite data held in the memory cell 1′ can be shortened compared with a method which controls the potential of the power source line PL. Therefore, a time period in which the P-channel field-effect transistor MP2 and the N-channel field-effect transistor MN1 become stress-free can be shortened, and it is possible to prevent the change of the threshold voltage due to PBTI or NBTI from being reduced by the stress-free, so that the degree of accuracy in the diagnosis of the range of the change of the threshold voltage due to PBTI or NBTI can be improved.

To shorten the time for diagnosing the change of the threshold voltage, data may be collectively read from the memory cells 1′ in the row direction or data may be collectively re-written to the memory cells 1′ in the row direction.

When short-circuiting the storage nodes nt and nc to each other or disconnecting the storage nodes nt and nc from each other, it is possible to perform the above operation on the memory cells 1′ collectively in the row direction, on the memory cells 1′ collectively in the column direction, or on all the memory cells 1 collectively.

### Fourth Embodiment

FIG. 10 is a block diagram illustrating a schematic configuration of a semiconductor integrated circuit to which a diagnostic circuit according to a fourth embodiment is applied.

In FIG. 10, a circuit block 12 and a diagnostic circuit 13 are mounted on the semiconductor chip 11. As the diagnostic circuit 13, the configuration in FIG. 1 may be used and the configuration in FIG. 7 may be used. As the circuit block 12, a semiconductor memory such as an SRAM may be used or a logic circuit such as a flip-flop and an inverter may be used.

In a situation in which transistors in the circuit block 12 degrade due to PBTI or NBTI, stress of PBTI or NBTI is also applied to the transistors in the memory cells of the diagnostic circuit 13. In the diagnostic circuit 13, the change of the threshold voltage of the transistors is properly diagnosed on the basis of the distribution of the data autonomously held in the memory cells, and if the transistors' useful life has ended, a diagnosis signal S3 is output to the outside. Here, the diagnosis timing may be set at a start-up time of the circuit block 12 or may be set at regular time intervals. If an end of the useful life of the circuit block 12 is diagnosed, the circuit block 12 may be operated by increasing a power source voltage or by lowering an operating frequency.

### Fifth Embodiment

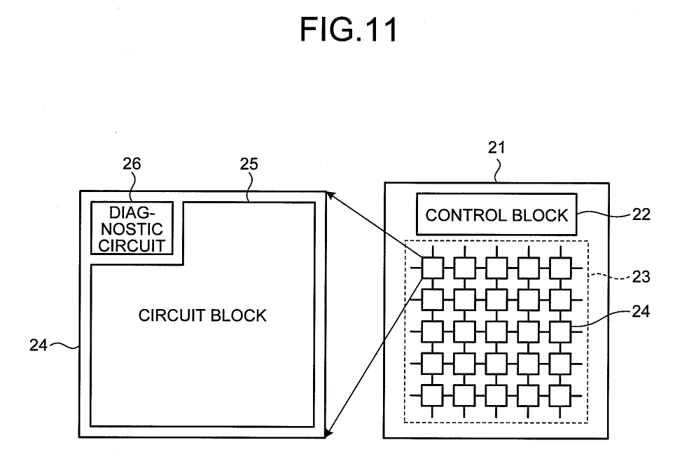

FIG. 11 is a block diagram illustrating a schematic configuration of a semiconductor integrated circuit to which a diagnostic circuit according to a fifth embodiment is applied.

In FIG. 11, a control block 22 and a multi-core group 23 are mounted on the semiconductor chip 21. A plurality of cores 24 are provided in the multi-core group 23. A circuit block 25 and a diagnostic circuit 26 are mounted on each core 24. As the diagnostic circuit 26, the configuration in FIG. 1 may be used and the configuration in FIG. 7 may be used. As the circuit block 25, a semiconductor memory such as SRAM may be used and a logic circuit such as a flip-flop and an inverter may be used.

In each core 24, in a situation in which transistors in the circuit block 25 degrade due to PBTI or NBTI, stress of PBTI or NBTI is also applied to the transistors in the memory cells of the diagnostic circuit 26. In the diagnostic circuit 26, the change of the threshold voltage of the transistors is properly diagnosed on the basis of the distribution of the data autonomously held in the memory cells, and the diagnosis result is output to the control block 22.

Then, the control block 22 preferentially assigns jobs to cores 24 in which the change of the threshold voltage of the transistors is relatively small, so that degradation of the transistors in the cores 24 is equalized. Here, the diagnosis timing may be set in assigning new jobs or may be set at the end of the jobs.

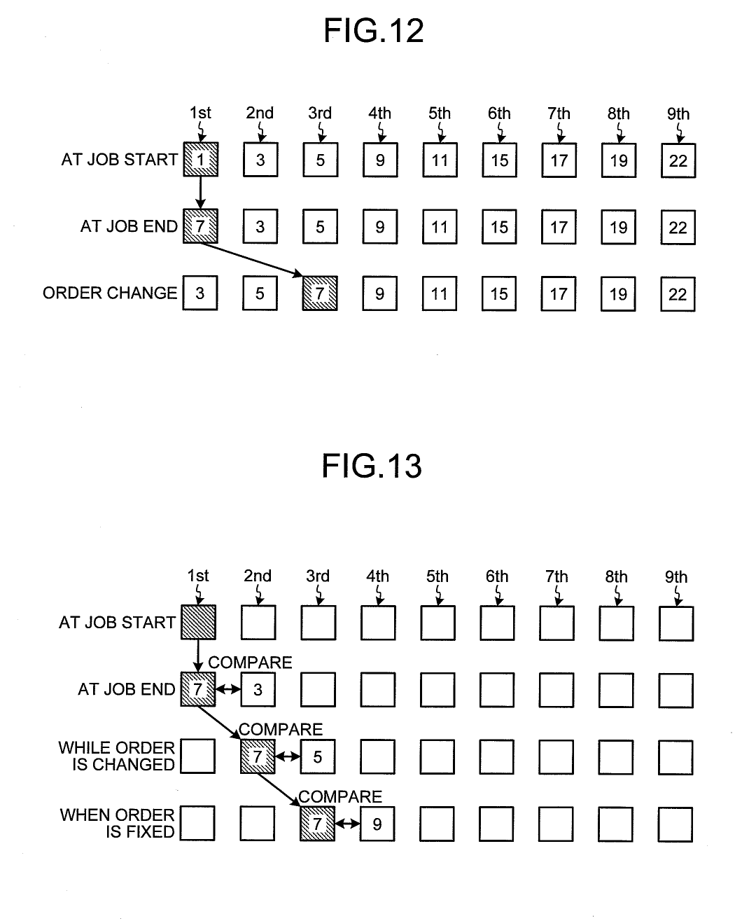

FIG. 12 illustrates an example of a method of a job assignment of the semiconductor integrated circuit illustrated in FIG. 11.

In FIG. 12, a degree of degradation and an order of each core 24 illustrated in FIG. 11 are held in the semiconductor chip 21, and new jobs are assigned to the core 24 whose degree of degradation is the smallest. Here, a register that holds the degree of the degradation and the order of each core 24 may be provided in the semiconductor chip 21. Then, only the core 24 to which the new jobs are assigned is diagnosed by the diagnosis circuit 26, and the degree of the degradation and the order of each core 24 are updated depending on the diagnosis result.

For example, when the core 24 whose degree of the degradation is ‘1’ is assumed to be the first in the order at a start time of the new jobs, the jobs are assigned to the core 24 whose degree of the degradation is ‘1’. The numeral in each square in FIG. 12 represents an example of the degree of the degradation of each core 24.

Then, the core 24 is assumed to be diagnosed on completion of the jobs of the core 24, and the degree of the degradation thereof is assumed to have become ‘7’. In this case, the degree of the degradation of the core 24 is updated to be ‘7’, the order thereof is updated to be the third, and the updated result is held in the semiconductor chip 21 at the same time. Besides, a core 24 whose degree of the degradation is ‘3’ is updated to be the first, and a core 24 whose degree of the degradation is ‘5’ is updated to be the second. Therefore, next new jobs are assigned to the core 24 whose degree of the degradation is ‘3’ at a start time of the next new jobs.

FIG. 13 illustrates another example of a method of a job assignment of the semiconductor integrated circuit illustrated in FIG. 11.

In FIG. 13, the order of the core 24 whose degree of the degradation is small is held in the semiconductor chip 21, and new jobs are assigned to the first core 24 in the order. Here, a register that holds the order of the core 24 whose degree of the degradation is small may be provided in the semiconductor chip 21. Then, only the core 24 to which the new jobs are assigned and a core 24 next in the order are diagnosed by the diagnosis circuit 26, and the order of the core 24 whose degree of the degradation is small is updated depending on the diagnosis result.

For example, the new jobs are assigned to the first core 24 in the order of the degree of the degradation at a start time of the new jobs. The numeral in each square in FIG. 13 represents an example of the degree of the degradation of each core 24.

Then, the core 24 and the next (second) core 24 are diagnosed on completion of the jobs of the core 24. Here, the degree of the degradation of the core 24 to which the new jobs are assigned is assumed to be ‘7’, and the degree of the degradation of the next core 24 is assumed to be ‘3’. In this case, since the degree of the degradation of the next core 24 is smaller than that of the core 24 to which the new jobs are assigned, the order of the core 24 to which the new jobs are assigned is postponed by one.

When the degree of the degradation of the next core 24 is smaller than that of the core 24 to which the new jobs are assigned, another next (third) core 24 is diagnosed. As a result of the diagnosis, the degree of the degradation of the third core 24 is assumed to be ‘5’. In this case, since the degree of the degradation of the third core 24 is smaller than that of the core 24 to which the new jobs are assigned, the order of the core 24 to which the new jobs are assigned is further postponed by one.

When the degree of the degradation of the third core 24 is smaller than that of the core 24 to which the new jobs are assigned, another next (fourth) core 24 is diagnosed. As a result of the diagnosis, the degree of the degradation of the fourth core 24 is assumed to be ‘9’. In this case, since the degree of the degradation of the forth core 24 is larger than that of the core 24 to which the new jobs are assigned, the order of the core 24 to which the new jobs are assigned is determined to be before the fourth core 24 and is fixed in the third position.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A diagnostic circuit comprising:
a memory cell array in which memory cells that complementarily store data in a pair of storage nodes are arranged;
an input/output circuit configured to make the memory cells hold a certain amount of data, and read data autonomously held in the memory cells after a state of the data held in the memory cells is transferred into an indefinite state; and
a diagnostic unit configured to diagnose a change of a threshold voltage of transistors on the basis of distribution of the data autonomously held in the memory cells.

2. The diagnostic circuit according to claim 1, wherein a certain amount of data is held in the memory cells when a circuit block diagnosed by the diagnostic unit operates.

3. The diagnostic circuit according to claim 1, further comprising a power source control circuit configured to transfer the state of the data held in the memory cells into an indefinite state by dropping a potential of power supplied to the memory cells to a ground potential.

4. The diagnostic circuit according to claim 3, wherein, when the power supplied to the memory cells is dropped to the ground potential and thereafter the power supplied to the memory cells is restored, the diagnostic unit determines an increase amount of the threshold voltage of transistors on the basis of a ratio of the number of read data whose value is “1” to the number of read data whose value is “0”.

5. The diagnostic circuit according to claim 4, wherein, in an initial state, the number of read data whose value is “0” and the number of read data whose value is “1” are equal to each other.

6. The diagnostic circuit according to claim 5, wherein, after a certain amount of data is held in the memory cells, an imbalance occurs between the number of read data whose value is “0” and the number of read data whose value is “1”.

7. The diagnostic circuit according to claim 1, wherein, the diagnostic circuit makes the memory cells hold a certain amount of data, then makes the memory cells hold the reverse data, and after a state of the data held in the memory cells is transferred to an indefinite state, the diagnostic circuit reads data autonomously held in the memory cells.

8. The diagnostic circuit according to claim 7, wherein, the reverse data is held in the memory cells so that it is possible to determine that the useful life has ended when the number of data “1” and the number of data “0” stored in the memory cells are the same.

9. The diagnostic circuit according to claim 1, further comprising an equalize control circuit configured to transfer the state of the data held in the memory cells into an indefinite state by short-circuiting the pair of storage nodes to each other.

10. The diagnostic circuit according to claim 9, wherein, when the pair of storage nodes are short-circuited to each other and thereafter the pair of storage nodes are disconnected from each other, the diagnostic unit determines an increase amount of the threshold voltage of transistors on the basis of a ratio of the number of read data whose value is “1” to the number of read data whose value is “0”.

11. The diagnostic circuit according to claim 10, wherein, in an initial state, the number of read data whose value is “0” and the number of read data whose value is “1” are equal to each other.

12. The diagnostic circuit according to claim 11, wherein, after a certain amount of data is held in the memory cells, an imbalance occurs between the number of read data whose value is “0” and the number of read data whose value is “1”.

13. The diagnostic circuit according to claim 9, wherein the memory cell includes
a first CMOS inverter in which a first P-channel field-effect transistor and a first N-channel field-effect transistor are connected to each other in series,
a second CMOS inverter in which a second P-channel field-effect transistor and a second N-channel field-effect transistor are connected to each other in series,
a first storage node provided at a connection point between the first P-channel field-effect transistor and the first N-channel field-effect transistor, and a third N-channel field-effect transistor connected between the first storage node and a first bit line,
a second storage node provided at a connection point between the second P-channel field-effect transistor and the second N-channel field-effect transistor, and a fourth N-channel field-effect transistor connected between the second storage node and a second bit line, and
a third P-channel field-effect transistor connected between the first storage node and the second storage node, wherein
outputs and inputs of the first CMOS inverter and the second CMOS inverter are cross-coupled to each other,
the gate of the third N-channel field-effect transistor and the gate of the fourth N-channel field-effect transistor are connected to a word line, and
the gate of the third P-channel field-effect transistor is connected to an equalize line.

14. A semiconductor integrated circuit comprising:
a circuit block; and
a diagnostic circuit configured to diagnose a change of a threshold voltage of transistors in the circuit block,
wherein the diagnostic circuit includes
a memory cell array in which memory cells that complementarily store data in a pair of storage nodes are arranged,
an input/output circuit configured to make the memory cells hold a certain amount of data, and read data autonomously held in the memory cell after a state of the data held in the memory cell is transferred into an indefinite state, and
a diagnostic unit configured to diagnose a change of a threshold voltage of transistors on the basis of distribution of the data autonomously held in the memory cells and output the diagnosis result.

15. The semiconductor integrated circuit according to claim 14, further comprising a power source control circuit configured to transfer the state of the data held in the memory cells into an indefinite state by dropping a potential of power supplied to the memory cells to a ground potential.

16. The semiconductor integrated circuit according to claim 14, further comprising an equalize control circuit configured to transfer the state of the data held in the memory cells into an indefinite state by short-circuiting the pair of storage nodes to each other.

17. A semiconductor integrated circuit comprising:
a circuit block in which multi-core is provided;
a diagnostic circuit which is provided for each core of the multi-core and diagnoses a change of a threshold voltage of transistors of the core; and
a control block configured to control job assignment for the cores on the basis of a diagnosis result of the diagnostic circuit,
wherein the diagnostic circuit includes
a memory cell array in which memory cells that complementarily store data in a pair of storage nodes are arranged,
an input/output circuit configured to make the memory cells hold a certain amount of data, and read data autonomously held in the memory cell after a state of the data held in the memory cell is transferred into an indefinite state, and
a diagnostic unit configured to diagnose a change of a threshold voltage of transistors on the basis of distribution of the data autonomously held in the memory cells.

18. The semiconductor integrated circuit according to claim 17, wherein the control block preferentially assigns jobs to cores in which the change of the threshold voltage of the transistors is relatively small.

19. The semiconductor integrated circuit according to claim 17, further comprising a power source control circuit configured to transfer the state of the data held in the memory cells into an indefinite state by dropping a potential of power supplied to the memory cells to a ground potential.

20. The semiconductor integrated circuit according to claim 17, further comprising an equalize control circuit configured to transfer the state of the data held in the memory cells into an indefinite state by short-circuiting the pair of storage nodes to each other.
